(19) United States
(12) Patent Application Publication
(10) Pub. No.: US 2014/0233780 A1
(43) Pub. Date: Aug. 21, 2014

(54) MODIFIED DIAPHRAGM SHAPES FOR IMPROVED AIR HORN PERFORMANCE

(71) Applicants: NETANEL RAISCH, Psagot (IL); Nir Bloch, Alon (IL)

(72) Inventors: NETANEL RAISCH, Psagot (IL); Nir Bloch, Alon (IL)

(21) Appl. No.: 13/769,400

(22) Filed: Feb. 18, 2013

(51) Int. Cl. H04R 1/00

(52) U.S. Cl. CPC H04R 1/00
USPC 381/340

(57) ABSTRACT

The invention discloses diaphragms for use in air horns or similar noise-producing devices. The diaphragms may have concave or convex non-linear shapes, wherein protrusions are included in the body of the rigid or semi-rigid diaphragm. The diaphragms made be made of any relevant materials and keep their non-flat shapes during and without application of compressed gas.

### FIELD AND BACKGROUND OF THE INVENTION

The present invention, in some embodiments thereof, relates to methods and devices for allowing greater sound energy to be realized from an air horn for a given applied air pressure. The instant invention, in some embodiments, describes a non-flat diaphragm whose shape and properties allows for more efficient sound wave production and more decibels of sound to be produced by an air horn.

The air horn is a well known element on tractor trailers, trains, as well as in sports and other activities. Air horns are well known for their incredibly powerful sound produced. Air horns generally work by exposing a diaphragm to high pressure air; vibrations of the diaphragm yield sound waves which are magnified in the iconic megaphone end of the air phone. Some air horns alternatively work by pushing high pressure air through a small hole to generate the initial sound waves.

While it has been known for over a century that sound waves can propagate over long distances in water, it is actually difficult to produce sound with an air horn in water. The initial sound waves produced by the motion of the diaphragm are quenched by the presence of water in the megaphone region of air horn. Even covering over the megaphone is of little use, as the added later serves to significantly dampen the sound waves that leave the horn and enter the water.

A big challenge for underwater air horns is the fact that most air horns release sound through the megaphone portion, but in an underwater environment the sound is “captured” in the air bubbles and not transferred to the water for sound wave propagation. In addition the bubbles' noise and the bubble “creation” process mask the air horn sound.

U.S. Pat. No. 7,908,991 to Woods, et al. teach a portable air horn apparatus includes a housing, an air horn assembly for generating a warning sound, a switch for activating the air horn assembly and a power source. A microprocessor is provided in communication with the switch, the air horn assembly and the power source. The microprocessor includes at least one port for receiving an electronic component and is capable of automatically loading and executing software of the electronic component.

European Patent EP0864107 to Harvey & Nedwell describes an acoustic generating system is described incorporating a bubble generator (1) for forming pressurised gas bubbles and directing the bubbles in a plume from an outlet (7), and a low frequency sound source (2) to apply a varying pressure to the base of the plume of bubbles to modulate (8) the plume of bubbles, whereby a source of low frequency sound waves is produced. A method for generating and transmitting a low frequency acoustic wave using is also described.

U.S. Pat. No. 3,125,061 to Liebermann teaches a horn for underwater use and, more particularly, to a moving diaphragm horn actuated by compressed fluid for underwater use. Prior fluid-operated horns are intended for use in air, rather than under water. These are designed for emitting warning signals, for trains, buses, trucks, etc. Air horns, when immersed in water, either fail to emit any sound or emit only a very weak sound. Hence, they cannot be used as suitable sound sources for underwater applications. The present invention is a fluid-operated horn which emits an intense tone while immersed in water. Previous horns emit strong tones in air, but when submerged in water, they either cease operating or emit a very weak signal. The present invention emits a strong tone in air and continues to emit a strong tone when submerged even to depths of several hundred feet.

U.S. Pat. No. 5,200,932 to Ljung teaches a signalling device with a long audible range is described, which is intended for underwater communication between divers. The device consists of a compact and lightweight horn and a rubber bulb. The horn, which works independently from a diver's supply of breathing air, is filled with water and operated by manually squeezing the rubber bulb.

U.S. Pat. No. 6,578,511 to Dexter et al. teaches an all-purpose, pneumatic powered signaling device including a first component capable of transmitting signals above water and a second component capable of transmitting a signal beneath the water. The first component includes a pneumatic air horn and the second component a diaphragm and piston. A button actuator is selectively depressed to create a flow passageway from a source of compressed air to the first and second components. A selector switch is selectively adjustable to allow a stream of compressed air flowing through the passageway to enter either the first or the second component and transmit a signal above or below the water.

U.S. Pat. No. 5,022,790 to Stevenson describes an audible signalling system is provided for us by divers or the like to provide a relatively loud audible signal which can be used to indicate diver position, to signal distress, etc. The preferred system utilizes an air horn carried by the diver and adapted for connection to a pressurized air supply carried by the diver for breathing purposes. When the air horn is connected to the air supply, the horn can be operated to produce a loud audio signal of substantial range which can be heard relatively easily over ambient noise such as wind, water and/or boat noise. In one form, a sonic oscillator for use in underwater signalling is also included.

The prior art generally describes air horns that use traditional flat diaphragms for activation of sound waves in response to application of pressurized air.

### SUMMARY OF THE INVENTION

It is therefore a purpose of the present invention, in some embodiments, to provide an alternative diaphragm with a non-flat shape for improved sound wave production in an air horn.

The invention includes a diaphragm for use in an air horn, wherein the diaphragm has a concave or convex profile or part of it substantially in the shape of a parabola or a plurality of superimposed or adjacent parabolas.

In one aspect of the diaphragm, the diaphragm is made of any of the following: plastic, metal, rubber, polymers, and composite materials.

In another aspect of the diaphragm, the diaphragm has a thickness between 0.05 and 5 millimeters.

In another aspect of the diaphragm, the parabola may described generally as a spherical sector having an h value greater than 0.1 millimeter.

In another aspect of the diaphragm, the diaphragm is associated with an air horn associated with one or the following: train, car, truck, motorcycle, moped, ship, bus, vehicle, bicycle, and alarm.

In another aspect of the diaphragm, the diaphragm is associated with a diver-safety device.

In another aspect of the diaphragm, the diaphragm is associated with an air horn used in underwater communication.

The invention additionally includes a diaphragm for use in an air horn, wherein the diaphragm has a rigid or semi-rigid non-flat resting surface shape.

In one aspect of the diaphragm, the diaphragm has an overall shape selected from one of the following: round, oval, square, rectangular, hexagonal, and triangular.

In another aspect of the diaphragm, the diaphragm is made of any of the following: plastic, metal, rubber, polymers, and composite materials.

The invention additionally includes a device for underwater communication, including the following: a source of compressed gas; an air horn, wherein the diaphragm associated with the air horn has a rigid or semi-rigid non-flat resting surface shape; a hose connecting the source of compressed gas to the air horn; and, an activation element for allowing gas from the source to pass through the air horn, wherein the gas causes the diaphragm to vibrate before the gas egresses the air horn.

In one aspect of the device, the source of compressed gas is a diver air tank.

In another aspect of the device, the compressed gas is realized as compressed air.

In another aspect of the device, the air horn is associated with a dive inflator.

In another aspect of the device, the activation element is associated with a diver safety device.

In another aspect of the device, the air horn includes connectors adapted on one side to connect to the hose and adapted on the second side to attach to the inflator.

In another aspect of the device, the diaphragm includes a generally spherical cap shape.

In another aspect of the device, the spherical cap generally has an h value of less than 0.01 mm.

In another aspect of the device, a diaphragm cover includes holes adapted to expose a portion of the diaphragm to the water.

Unless otherwise defined, all technical and/or scientific terms used herein have the same meaning as commonly understood by one of ordinary skill in the art to which the invention pertains. An air horn may generally refer to an air horn device as commonly understood. FIG. 1 shows a typical diagram for a prior art air horn device. With respect to functionality, a diaphragm for the present invention may generally perform the same role as it generally performs in prior art air horns.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings will have the same number, advanced by the appropriate multiple of 100.

In the drawings:

FIG. 1 shows a schematic cutaway view of a prior art air horn device;

FIGS. 2A-2B show schematic views of prior art diaphragm;

FIGS. 3A-3D show schematic views of instant diaphragms based on spherical sectors;

FIG. 4 shows a diaphragm sporting a non-circular shape;

FIG. 5 shows a schematic view of a concave diaphragm according an embodiment of the instant invention; and,

FIGS. 6A-6B shows a schematic view of a diaphragm according to an embodiment of the instant invention as employed in an air hose.

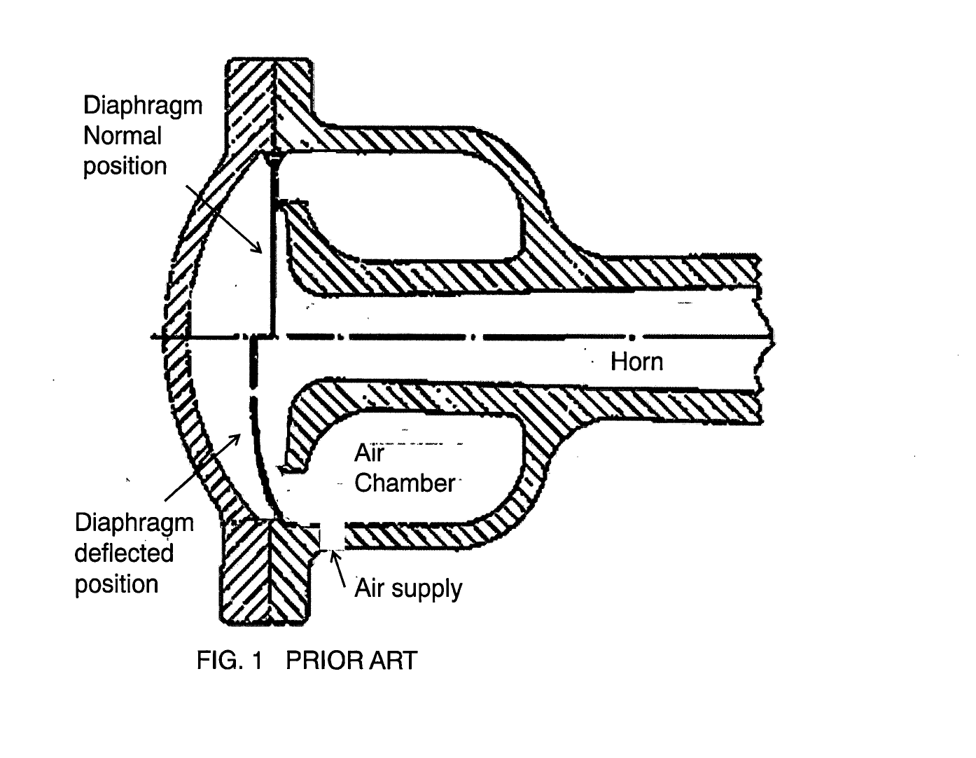

### DESCRIPTION OF SPECIFIC EMBODIMENTS OF THE INVENTION

The present invention, in some embodiments thereof, relates to an air horn diaphragm not having a flat shape. Without being bound by any particular theory, the following discussion is offered to facilitate understanding of the invention. The present invention, in some embodiments, provides for a diaphragm with non-flat features which increase the amount of sound energy produced for a given amount of compressed air or other gas applied to the air horn.

For purposes of better understanding, some embodiments of the present invention are illustrated in the figures of the drawings.

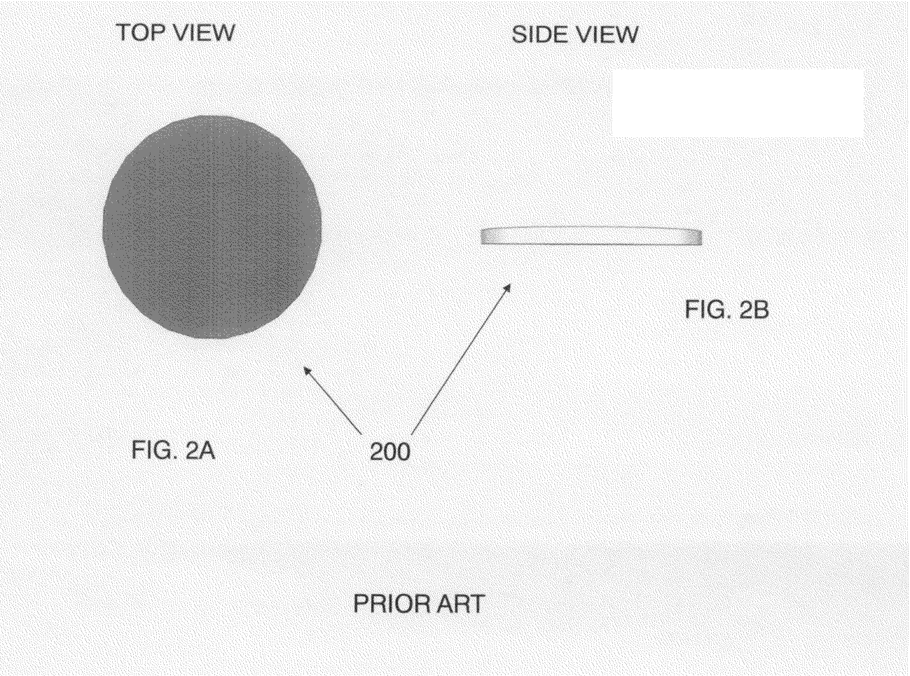

Attention is turned to FIG. 2A which shows a schematic view of a prior art diaphragm 200 used in an air horn. The top view (left) shows the diaphragm 200 having a generally circular shape, while the side view (FIG. 2B) shows the diaphragm 200 having a consistent thickness across the surface of the diaphragm 200. Diaphragms are generally circular with thicknesses ranging from tens of millimeters to a few millimeters. Diaphragms are generally flat when viewed from the side FIG. 2B. Materials used for diaphragm manufacture may vary, depending on the application as well as the sound requirements. Prior art diaphragms generally do not have any features protruding from above or below their generally flat, circular bodies.

The diaphragm according to some embodiments of the instant invention works much better in the case where an associated diaphragm cover is not sealed, as in this case the vibrations transferred from the diaphragm to the water go not through the megaphone but are transferred to the water from the other side of the diaphragm.

### First Embodiment

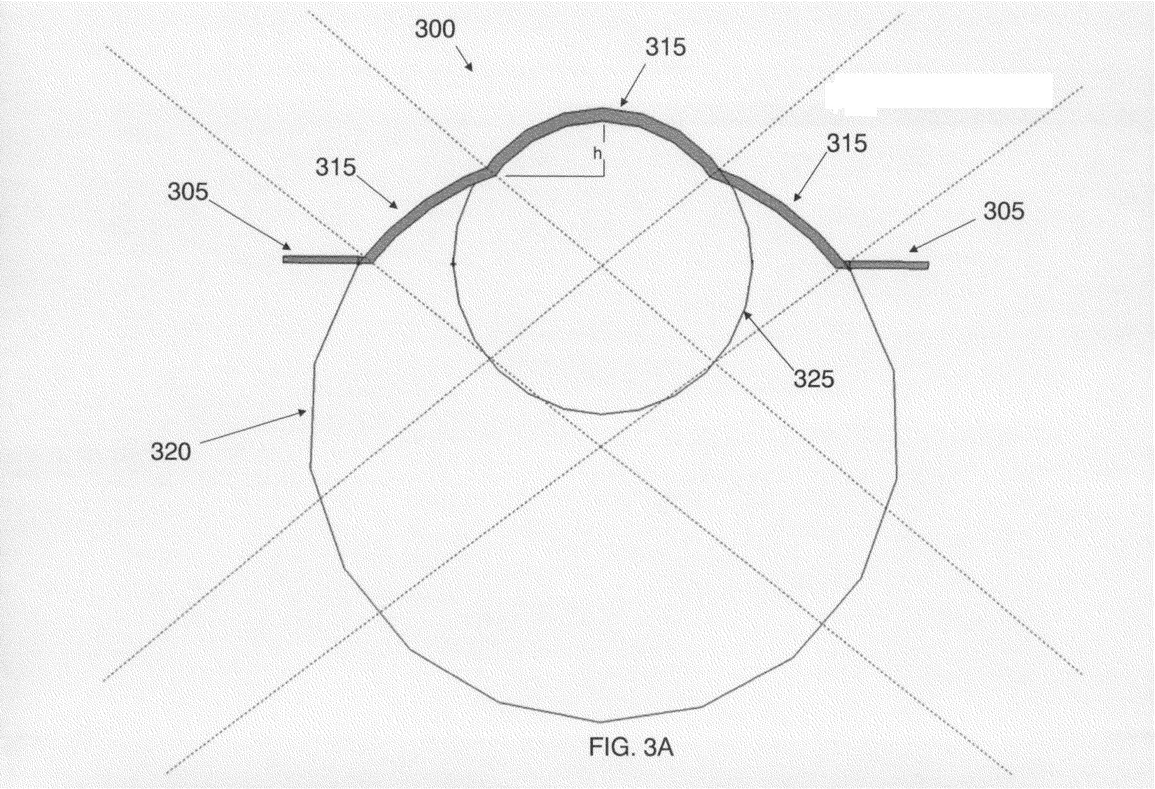

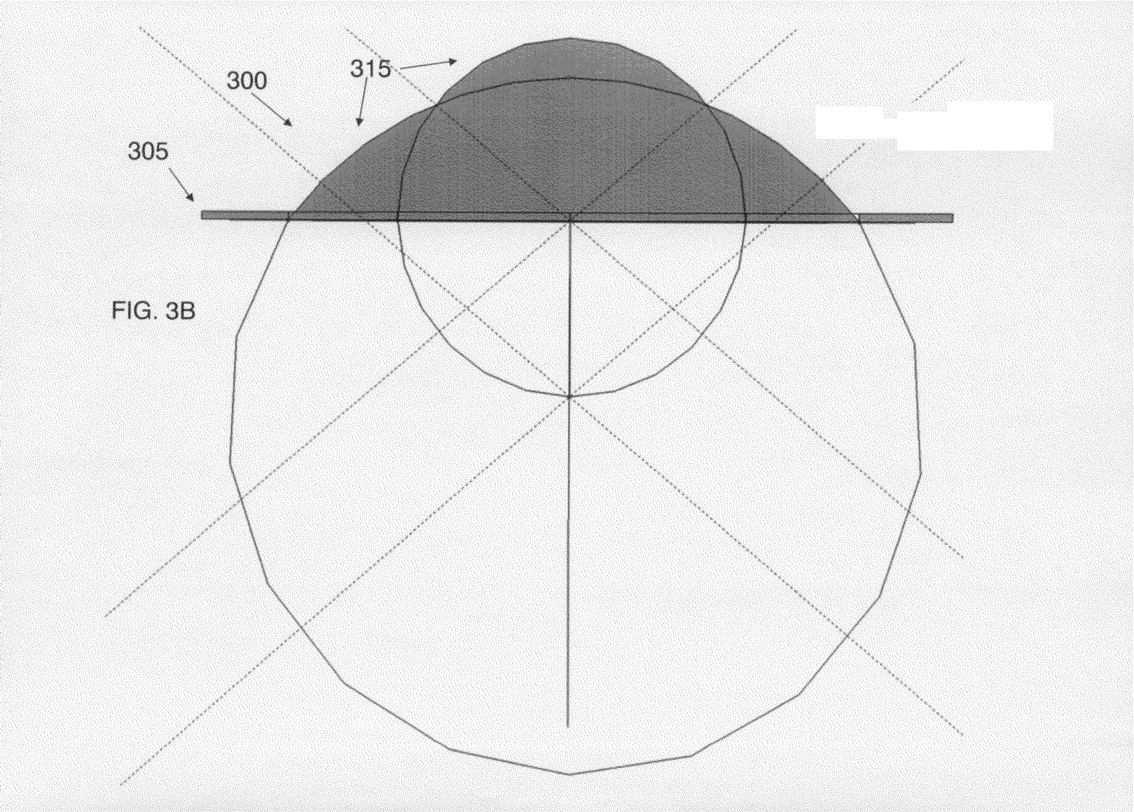

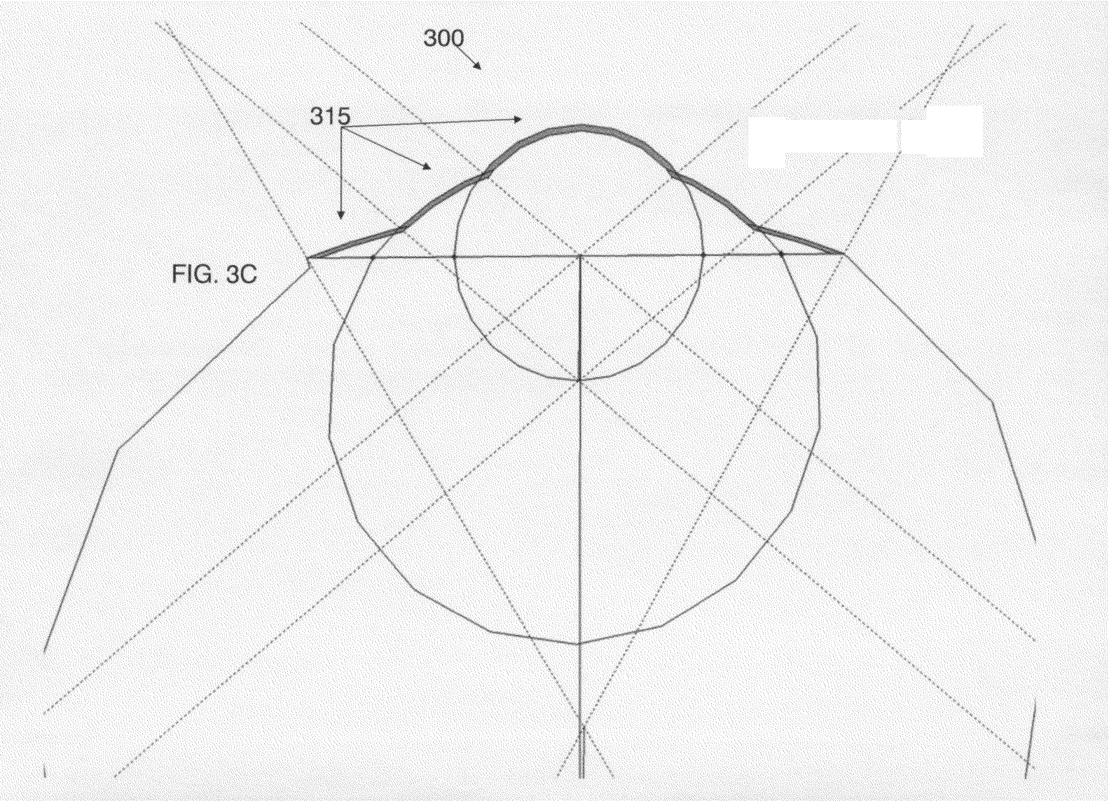

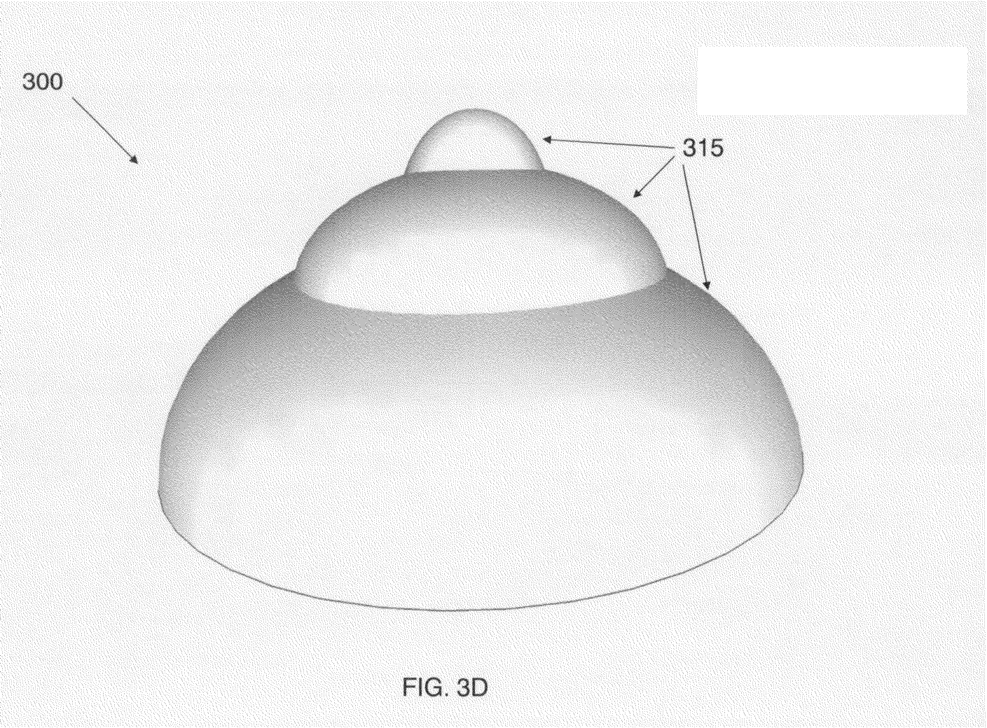

Attention is turned to FIG. 3A which shows a schematic cut-away view of a diaphragm 300 according to an embodiment of the invention. The diaphragm 300 shows flat ends 305 and a middle region that has protrusions 315 generally shaped by the edges of spheres 320 & 325, wherein the diaphragm assumes the shape of spherical caps (http://en.wikipedia.org/wiki/Spherical_cap) associated with the spheres 320 & 325. The spheres 320 & 325 are shown for convenience only and are not part of the diaphragm 300.

In the instant invention, only the flat ends 305 are flat like prior art diaphragms. The main body of the diaphragm 300 has protrusions 315 which define a non-flat surface. The protrusions 315 may face towards the horn (not shown) or away from the horn, as both arrangements appear to give significantly greater sound per amount of compressed air applied to the air horn.

Attention is turned to FIG. 3C which shows an additional cut-away view of a diaphragm 300 according to this embodiment of the instant invention. Protrusions 315 follow the spherical caps associated with three spheres 320, 325, & 328. There are no flat ends for this diaphragm 300. The diaphragm 300 in an air horn (not shown) and is pressed into place by a cover associated with air horn. In this diaphragm 300, all of the diaphragm 300 is associated with protrusions, with no flat ends or overall flat surfaces. FIG. 3B shows a space-filling view of the diaphragm 300, with protrusions 315 and flat ends 305 visible. FIG. 3D shows a space-filling model of the diaphragm 300 with its protrusions 315 as they would appear in a fabricated diaphragm 300. “h”, the height of each spherical cap, may generally have a value for spherical sectors employed in the instant invention less than 0.1 millimeters. It is understood that the angle of joining between successive protrusions 315 may be of any appropriate angle, both higher and lower than 90 degrees. It is also understood that protrusions 315 may be of any relevant shape including but not limited to circular, conical, parabolic and hemispheric.

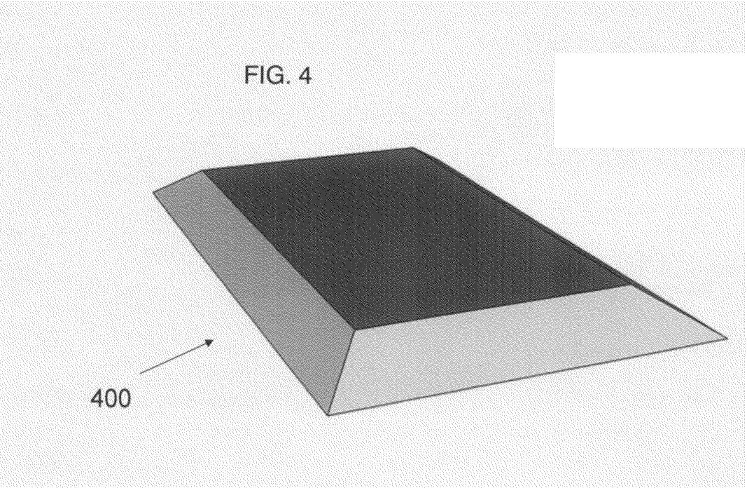

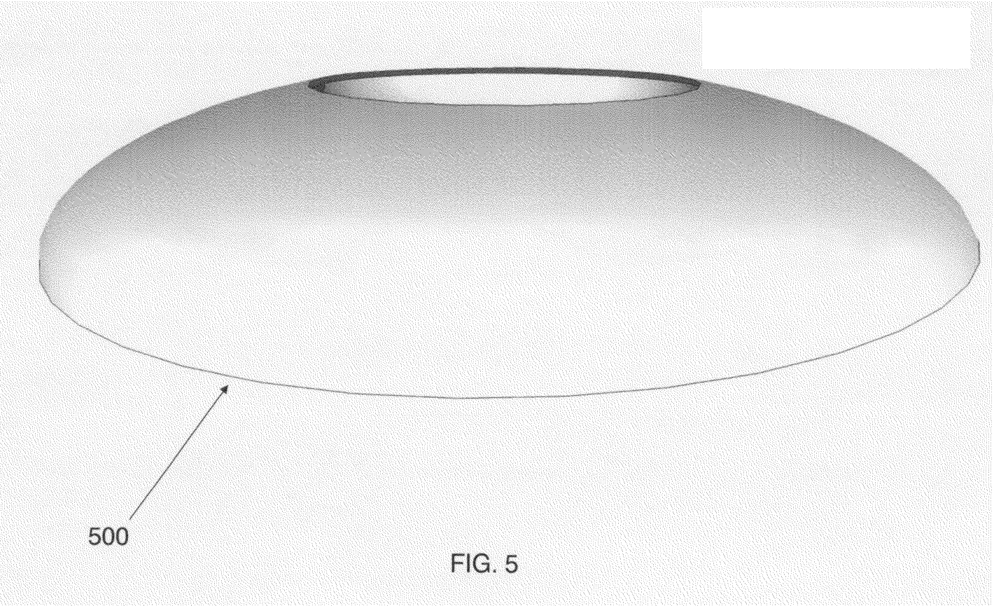

It is noted that the protrusions 315 do not have to follow any particular geometric pattern but rather can be of any shape or size and can appear on one or both sides of a diaphragm 300. The protrusions 315 may follow spherical caps as shown herewith, or spherical sectors; alternatively, they be made of any shape. Additionally, the diaphragm 300 does not have to be round in its overall shape; it could alternatively be square, rectangular (FIG. 4), triangular, or other shape, with the components of the air horn holding the diaphragm in place having similar shapes to hold the diaphragm tightly in place for optimal function. The diaphragm could have less spherical sectors or caps or more than 3 spherical sectors as shown in the embodiments. A diaphragm may be a concave (500, FIG. 5) or a convex (400, FIG. 4) shape.

Additionally, the instant invention has applicability of any materials used for diaphragm construction, including but not limited to metals, plastic, composites, foils, polymers, glasses, threads, and fibers. All materials that may be shaped into non-flat objects of predetermined diameter, thickness and protrusion properties are amenable for use in the instant invention.

### Second Embodiment

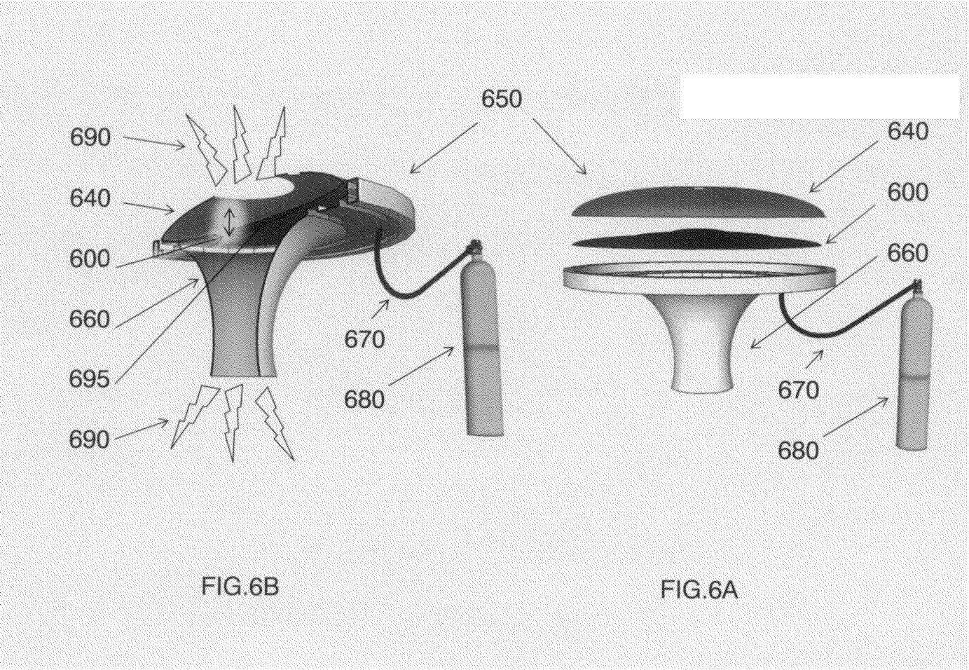

Attention is turned to FIG. 6A which shows an air horn 650 and some of its parts. A non-flat diaphragm 600 is placed between a cap 640 and a horn 660. In FIG. 6B, the components are connected, wherein the compressed diaphragm 600 sits securely between the cap 640 and the horn 660. A hose 670 brings compressed air from an air tank 680 to the air horn 650. Air causes the diaphragm 600 to vibrate 695, the sound waves thus produced being rapidly expanded in the horn 660 to lead to a loud sound 690 as suggested.

The cap 640 may be a full cap which seals the diaphragm from the environment or alternatively it may be a partially open cap which exposes the diaphragm to the surroundings and lets a portion of the generated sound exit from the cap 640 side. The cap 640 may be associated with a large or small holes to aid in the egress of sound waves from the cap 640 side of the horn.

### Example

In an air horn made from nylon 12 with 19 millimeter diameter and 9 bar air pressure specification, and including a 0.5 mm hole for air pressure into the air horn, a flat standard diaphragm made by plastic or metal achieved 90 decibels sound. A diaphragm with protrusions as per an embodiment of the instant invention with the same air horn specifications made from plastic with a thickness of 0.2 millimeters and 3 spherical sections of radiuses of 0.9, 0.7 and 0.4 mm respectively (see FIG. 3D), achieved an output of 140 decibels on air and a clear sound underwater. Thus, changes in diaphragm shape allowed for a 50 decibel output increase from the same air pressure and same air horn dimensions.

It is understood that some embodiments of the instant invention may include a plurality of diaphragms for use in a single or multiple air horns. Diaphragms according to the instant invention may have any thickness, though 0.05 to 5 millimeters is preferred.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the, method or structure may include additional ingredients, steps and/or parts, but only if the additional ingredients, steps and/or parts do not materially alter the basic and novel characteristics of the claimed composition, method or structure.

The term “air” may refer to any gas.

The term “air horn” may refer to any device which use diaphragm to make a noise.

“Resting surface shape” with respect to a diaphragm generally refers to the shape of the diaphragm when no air pressure is applied to it.

The term “diaphragm” may refer to a thin, semi-rigid membrane that vibrates to produce or transmit sound waves.

The term “compressed air” may mean any gas which compressed mechanically or manually or orally with machine help or without.

“h” may refer to the height of a spherical cap as defined here: http://en.wikipedia.org/wiki/Spherical_segment

As used herein, the singular form “a”, “an” and “the” include plural references unless the context clearly dictates otherwise.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. The present invention could be employed for a wide variety of embodiments with differentially sized diaphragm elements as herewith described. The instant invention may be employed in any line of human activity including but not limited to underwater communication, underwater alert, honking, warning, sports communication, and military use.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed:

1. A diaphragm for use in an air horn, wherein said diaphragm has a concave or convex profile or part of it substantially in the shape of a parabola or a plurality of superimposed or adjacent parabolas.

2. The diaphragm according to claim 1, wherein said diaphragm is made of any of the following: plastic, metal, rubber, polymers, and composite materials.

3. The diaphragm according to claim 1, wherein said diaphragm has a thickness between 0.05 and 5 millimeters.

4. The diaphragm according to claim 1, wherein said parabola may described generally as a spherical sector having an h value greater than 0.1 millimeter.

5. The diaphragm according to claim 1, wherein said diaphragm is associated with an air horn associated with one or the following: train, car, truck, motorcycle, moped, ship, bus, vehicle, bicycle, and alarm.

6. The diaphragm according to claim 1, wherein said diaphragm is associated with a diver-safety device.

7. The diaphragm according to claim 1, wherein said diaphragm is associated with an air horn used in underwater communication.

8. A diaphragm for use in an air horn, wherein said diaphragm has a rigid or semi-rigid non-flat resting surface shape.

9. The diaphragm according to claim 8, wherein said diaphragm has an overall shape selected from one of the following: round, oval, square, rectangular, hexagonal, and triangular.

10. The diaphragm according to claim 8, wherein said diaphragm is made of any of the following: plastic, metal, rubber, polymers, and composite materials.

11. A device for underwater communication, including the following:
a source of compressed gas;
an air horn, wherein the diaphragm used in said air horn has a rigid or semi-rigid non-flat resting surface shape;
a hose connecting said source of compressed gas to said air horn; and,
an activation element for allowing gas from said source to pass through said air horn, wherein said gas causes said diaphragm to vibrate before said gas egresses said air horn.

12. The device according to claim 11, wherein said source of compressed gas is a diver air tank.

13. The device according to claim 11, wherein said compressed gas is realized as compressed air.

14. The device according to claim 11, wherein said air horn is associated with a dive inflator.

15. The device according to claim 11, wherein said activation element is associated with a diver safety device.

16. The device according to claim 11, wherein said air horn includes connectors adapted on one side to connect to said hose and adapted on said second side to attach to said inflator.

17. The device according to claim 11, wherein said diaphragm includes a generally spherical cap shape.

18. The device according to claim 17, wherein said spherical cap generally has an h value of less than 0.01 mm.

19. The device according to claim 11, wherein a diaphragm cover includes holes adapted to expose a portion of said diaphragm to the water.
